(19) United States
(12) Patent Application Publication
(10) Pub. No.: US 2021/0215180 A1
(43) Pub. Date: Jul. 15, 2021

(54) ACTUATOR SYSTEM, PIECE OF FURNITURE AND METHOD FOR CONTROLLING AN ACTUATOR SYSTEM

(71) Applicant: LOGICDATA Electronic & Software Entwicklungs GmbH, Deutschslandsberg (AT)

(72) Inventor: Gerhard Robier, Deutschlandsberg (AT)

(21) Appl. No.: 17/144,460

(22) Filed: Jan. 8, 2021

(30) Foreign Application Priority Data
Jan. 10, 2020 (DE) 102020100439.7

(51) Int. Cl. F16B 7/14; A47B 9/20; A47B 9/04; H02K 7/102

(52) U.S. Cl. CPC F16B 7/1409; A47B 9/20; A47B 9/04; F16B 2001/0035; A47B 2009/046; A47B 2200/0052; A47B 2200/0059; H02K 7/1023

(57) ABSTRACT

An actuator system includes a motor having a system of rotating shafts, a conversion arrangement including one of the rotating shafts and converting rotational motion to elongation, and a brake arrangement having one of the rotating shafts as a brake shaft, an electromagnet, at least one brake chamber formed between the brake shaft and an associated brake wall, and a magnetoactive brake member for each brake chamber. Each brake chamber includes a free-wheeling region for receiving the respective brake member. Each brake chamber includes a braking region with a decreasing radial distance between wall and rotation axis. Each brake member is arranged movably in the respective brake chamber in such a way that frictional contact can be formed with the brake shaft and brake wall. In an activated state, the electromagnet is configured to bring each brake member into the associated free-wheeling region.

### CROSS REFERENCE TO RELATED APPLICATIONS

This application claims priority to German Application number 10 2020 100 439.7 filed on Jan. 10, 2020, the contents of which are incorporated by reference in their entirety.

### FIELD

The present disclosure relates to an actuator system, a piece of furniture comprising such an actuator system, and a method for controlling such an actuator system.

### BACKGROUND

Adjustable furniture is known in the field of office furniture as well as in the field of home furniture. The most common designs in the office furniture sector are, for example, electrically adjustable tables or chairs, while electrically adjustable beds, seating furniture or reclining furniture are known in the home sector.

The adjustment is usually performed by linear actuators or similar actuator systems, which are built into one or more columns of the table or into a frame of the bed, seating furniture or reclining furniture.

Such actuators are usually formed by an electric motor, which drives a motor shaft, and a conversion arrangement, which converts a rotation of the motor shaft into a linear displacement of the actuator. For example, spindle-nut systems are used as such conversion arrangements, where a spindle is driven by the motor shaft via a gearbox and causes a linear displacement of the nut. Using the example of a table, this then causes the table top to be raised or lowered.

However, to ensure that a force acting in a linear direction on the actuator, for example by a table top, does not inversely lead to a rotation of the spindle or motor shaft, the components acting together are usually designed accordingly. For example, a friction between the components is deliberately chosen to be high enough to create self-locking. However, the degree of self-locking also determines the efficiency of the actuator. Accordingly, more energy must be expended for linear adjustment of the actuator with a high degree of self-locking than with low or non-existent self-locking. In conventional linear actuators and similar actuator systems, a trade-off must therefore be made between acceptable efficiency and necessary self-locking.

### SUMMARY

This disclosure provides an improved drive concept that enables improved efficiency of an actuator system.

The improved drive concept is based on the insight that, in an actuator system, feedback effects from the output side to the input side can basically occur in both input directions, which can lead to undesirable behavior of the overall system. Such undesirable feedback effects can be triggered, for example, by gravitational forces, such as the weight force of a tabletop or the weight force of a table frame or, in the case of a bed, the weight force of a mattress.

Accordingly, the improved drive concept proposes to selectively retard or selectively cancel a braking effect on a movement of the drive side, such as a motor shaft, to thereby selectively retard or ultimately block a rotation of the motor shaft and coupled shafts therewith. Such a braking effect can be provided either for both possible directions of rotation of the shafts or alternatively only in a selected direction of rotation, while in a second direction of rotation rotation is possible without hindrance.

In a motor comprising a system of rotating shafts which are driven by the motor interdependently, a brake arrangement is provided for this purpose, which comprises one of the rotating shafts as a brake shaft. The brake arrangement comprises at least one brake chamber formed between the brake shaft and an associated brake wall having a wall surface substantially parallel to an axis of rotation of the brake shaft, and for each brake chamber a brake member disposed in the brake chamber. In order to achieve the selective braking effect, the brake chamber comprises at least two regions, namely one in which the brake member is supported in such a way that it has no contact with the brake shaft and thus generates no braking effect, and another region in which the radial distance between the brake wall and the axis of rotation decreases and in which the brake member can form a frictional contact with the brake wall and the brake shaft. In the latter area, the braking effect thus increases the smaller the distance between the brake shaft or axis of rotation and the brake wall becomes.

The brake member, which is cylindrical or roll-shaped, for example, is pressed in the direction of the decreasing distance by the frictional contact and the resulting rotation of the brake member, so that the braking effect increases.

However, in order to selectively cancel the braking effect or leave it in the cancelled state, the brake member is specifically brought into the area of the brake chamber or held there where it has no frictional contact with the brake shaft. According to the improved drive concept, this is done by means of an electromagnet that pulls the magnetoactive brake member into a free-wheeling position or holds it there. In this context, magnetoactive means that magnetic fields exert a force on the braking element. This is achieved, as is known, by appropriate selection of a material, such as a ferrous or ferromagnetic material.

The system of rotating shafts is formed, for example, by a motor shaft, which is rigidly connected, for example, to a rotor of the motor, a gear shaft of a speed reduction gear, which is coupled on the input side to the motor shaft and on the output side to a spindle of the conversion arrangement. The spindle is thereby also a component of the rotating shaft system. In alternative embodiments, for example in the case of a direct drive, the spindle can also be coupled directly to the motor shaft or alternatively be identical to the motor shaft. In the latter case, the rotating shaft system would consist of only one shaft. The brake shaft may in principle be formed by any shaft of the system of rotating shafts.

In one embodiment of an actuator system comprising a motor, a conversion arrangement and a brake arrangement as described above, the brake arrangement comprises at least one brake chamber with associated magnetoactive brake member arranged in the brake chamber. Thereby, each brake chamber comprises a free-wheeling region configured to receive the respective brake member such that the brake member does not have frictional contact with the brake shaft. In addition, each brake chamber comprises at least one brake region in which a radial distance between the brake wall and the axis of rotation along the brake wall decreases, for example continuously, starting from the free-wheeling region. Each brake member is arranged movably in the respective brake chamber in such a way that, depending on its position in the brake chamber, frictional contact can be formed between the brake member and the brake shaft and between the brake member and the brake wall. In an activated state, the electromagnet is configured to bring each brake member into the associated free-wheeling region and preferably to hold it there.

The braking effect thus unfolds automatically, so to speak, since when the electromagnet is deactivated, for example also in the event of a failure of the supply voltage, the brake member or members are no longer held in the respective brake chamber and can thus enter the braking region, depending on the direction of rotation of the brake shaft, in order to bring about braking or blocking of a rotational movement. Due to the tapered implementation of the brake chamber, i.e. the decreasing radial distance, the braking effect increases automatically, depending on the direction of rotation, since the brake member is brought further into the tapered area by the frictional contact.

Depending on the design of the brake wall, this could result in the brake member or the brake shaft and the brake wall being subjected to ever-increasing loads. Accordingly, in various embodiments, each brake chamber has a limiting region in which the respective brake wall comprises a limiter for limiting a movement of the respective brake member along the respective brake wall. This limits, for example, a maximum clamping force between the brake wall, the brake member and the brake shaft.

For example, the brake arrangement is arranged to move this brake member in the associated brake chamber in a direction in which the radial distance decreases as a result of the frictional contact of the respective brake member, so that a clamping force between the respective brake member and the associated brake wall and the brake shaft increases.

In various embodiments, the brake arrangement has at least two brake chambers, with at least one of the brake chambers being associated with each of two possible braking directions.

The respective brake walls are formed, for example, in an annular body around the brake shaft. This enables, for example, a simple and stable construction, which can be manufactured with little effort and can be easily mounted on the brake shaft. The annular body can, for example, be connected to a housing part of the actuator system. For example, the respective brake chambers are arranged regularly around the brake shaft, approximately symmetrically with respect to each other. The symmetry is, for example, a mirror symmetry with respect to an axis perpendicular to the axis of rotation. For example, the radial distance to the axis of rotation changes according to a logarithmic spiral, especially in the braking region of a brake chamber. This can have an advantageous course for the increase of the braking effect.

Due to the clamping force between the respective brake member and the associated brake wall as well as the brake shaft, a mechanical load can arise for the brake shaft depending on the positioning of the brake chambers and/or the selection of the materials of the components involved. Therefore, for some embodiments, the improved drive concept provides that the brake arrangement comprises a support for the brake shaft that prevents or at least reduces bending of the brake shaft during braking. For example, opposing brake members may support each other during braking.

In some embodiments, the support is formed by a bearing component for the brake shaft, which at least in sections does not completely enclose the brake shaft in such a way that the bearing component is at least partially opposite a brake chamber with respect to the axis of rotation. Thus, a force acting on the brake shaft through a brake member is supported by the bearing component. The bearing component is formed, for example, by a plain bearing.

In various embodiments, each brake member has a rotationally symmetrical groove or notch, and each brake wall has an edge that engages the respective groove or notch of the associated brake member. In this way, for example, displacement of the brake member in a direction parallel to the axis of rotation can be restricted, while at the same time rotation of the brake member about an axis parallel to the axis of rotation remains possible. Falling out of the brake member from the brake chamber is thus prevented.

In various embodiments of the actuator system, the electromagnet may have at least one pair of magnetic poles forming a straight line parallel or substantially parallel to the axis of rotation. As a result, a uniform magnetic field can be generated in the region of the brake shaft, which can reliably bring the brake member or members into the free-wheeling region and hold them there.

For example, the electromagnet has a coil and a coil core, with parts of the coil core located outside the coil forming arms of the electromagnet, at the ends of which poles of the electromagnet are formed. On the one hand, this enables a compact design of the electromagnet and, on the other hand, a targeted application of the magnetic field in the area of the brake shaft and the brake walls. For example, the arms extend on both sides of the coil core, allowing the poles of different polarity to be formed. For example, the poles of the electromagnet are located in the vicinity of the brake walls or the brake wall, in particular in the vicinity of the free-wheeling regions of the respective brake chambers.

In various embodiments, each brake wall further comprises a respective reset mechanism arranged to bring the associated brake member into contact with the brake shaft in the non-activated state of the electromagnet. The reset mechanism can thus ensure that the brake member can come into frictional contact with the brake shaft in order to develop the corresponding braking effect.

The reset mechanism is formed, for example, by at least one inclined plane which is inclined radially to the brake shaft in such a way that a gravitational force acts on the respective brake member. Accordingly, the brake wall has the inclined plane along which the braking element can experience a gravitational force, for example by sliding along the inclined plane in the direction of the brake shaft. For example, the inclined plane is formed by or at the previously described edge in the brake wall which engages the groove or notch of the brake member. Thus, for example, the brake member rests with parts of the groove on the inclined plane of the edge and can slide in the direction of the brake shaft due to the gravitational force.

The reset mechanism can also be formed by at least one spring element by which the respective brake member is biased towards the brake shaft. For example, such a spring element penetrates the brake wall, for example in the free-wheeling region, so that the respective brake member is pressed out of the free-wheeling region by the spring force.

The reset mechanism is dimensioned in each case in such a way that, on the one hand, it is ensured that the brake member can develop a braking effect in the non-activated state of the electromagnet, but is held securely in the free-wheeling position in the activated state of the electromagnet.

The actuator system can, for example, be designed as a linear actuator, but also includes arrangements in which the motor and the converter arrangement are arranged separately from one another, in particular not in the same housing, whereby transmission of the rotary motion of the motor shaft to the converter arrangement can take place in a wide variety of ways.

The actuator system may further comprise an actuator control. Here, for example, the brake arrangement is arranged to assume a free-wheeling state and at least one braking state. In the free-wheeling state, each brake member is in the respective free-wheeling position. In the at least one braking state, at least one brake member has frictional contact with the brake shaft.

For example, the actuator control is arranged to activate the electromagnet and drive the motor to rotate the brake shaft to enable a change in elongation of the actuator system when the brake assembly is in the at least one braking state.

Thus, to enable the change of elongation of the actuator system, it is first necessary to bring the brake member or members into the free-wheeling position so that the free-wheeling state can be assumed. Only in this free-wheeling state is unobstructed rotation of the rotating shaft system possible, which is the basis for changing the elongation. In the at least one braking state, it may be that the brake member is already jammed between the brake wall and the brake shaft in such a way that the electromagnetic force alone is not sufficient to bring the brake member into the free-wheeling position. Accordingly, a movement of the brake shaft is first initiated, in particular against the current braking direction, so that a jamming of the brake member between brake wall and brake shaft is at least partially released and the brake member can be brought unhindered into the free-wheeling position. The initial rotational movement, in particular its direction, can thus be independent of a desired direction of rotation in the subsequent free-wheeling state, in which the elongation is changed by further actuation of the motor.

In various embodiments, the actuator control is further arranged to activate the electromagnet with a first intensity to bring the brake arrangement from the at least one braking state to the free-wheeling state, and to activate the electromagnet with a second intensity to keep the brake arrangement in the free-wheeling state, wherein the first intensity is higher than the second intensity. In particular, the higher first intensity makes it possible to bring the brake member into the free-wheeling position even when the brake member is in an unfavorable position in the brake chamber. The lower second intensity is selected so that it is only sufficient to hold the free-wheeling position. This allows energy to be saved during operation of the actuator system.

A transition of the braking arrangement from the free-wheeling state to the at least one braking state can be effected, for example, by driving the motor to a rotational motion of the brake shaft and/or by applying force to the conversion arrangement along a direction of elongation, while in each case the electromagnet is deactivated. The braking state, so to speak, can thus be achieved both actively and passively. In other words, the at least one braking state can be assumed in an actively controlled manner, or it can be assumed by mechanical loading from the outside. For example, in the event of a power supply failure in an electrically height-adjustable table, the force acting on the tabletop would cause the actuator system to enter the braking state because the brake member(s) would no longer be held in the free-wheeling position by the electromagnet. This provides an inherent safeguard against undesired lowering of the height-adjustable table.

The actuator control can be configured to activate the electromagnet with a pulse width modulated, PWM, voltage. This allows, for example, the use of known control components that are used for pulse-width modulated control of direct current and/or alternating current motors. For example, a free channel of a multi-channel PWM controller can be used to control the electromagnet, the remaining channels of which are used to control the electric motor(s). PWM control of the voltage can also be used to control the intensity of the magnetic field.

An actuator system of the type described according to the improved drive concept can be mechanically dimensioned for low self-locking, which comes into effect when the electromagnet is activated and thus the brake member(s) do not develop a braking effect. However, the self-locking of the actuator system increases automatically when the electromagnet is deactivated due to the increasing braking effect of the respective brake member. Thus, when the electromagnet is activated, the actuator system can be operated with lower energy expenditure than a conventional actuator with higher self-locking. For example, the additional energy required by activating the electromagnet is less than the energy required by the greater self-locking in a conventional actuator.

In various embodiments, the actuator control is attached to the actuator system or forms an integrated unit with a part of the linear actuator, for example the motor. Alternatively, the actuator control may be arranged separately from the other components of the actuator system, for example in a control unit.

According to the improved drive concept, a piece of furniture with at least one adjustable component and with an actuator system according to one of the embodiments described for adjusting the component is also proposed. Such pieces of furniture are, for example, tables, beds or adjustable seating and reclining furniture.

The improved drive concept also relates to a method for controlling an actuator system according to one of the embodiments described. Here, the brake arrangement is configured to assume a free-wheeling state and at least one braking state, wherein in the free-wheeling state each brake member is in the respective free-wheeling position, and in the at least one braking state at least one brake member has frictional contact with the brake shaft. The method comprises, to enable a change in elongation of the actuator system when the brake assembly is in the at least one braking state, activating the electromagnet and driving the motor to rotational motion of the brake shaft.

Further embodiments of the method will be apparent immediately from the various embodiments set forth in connection with the description of the actuator system and, in particular, the actuator control system.

### BRIEF DESCRIPTION OF THE DRAWINGS

In the following, the disclosure is explained in detail by means of example embodiments with reference to the drawings. Components which are functionally identical or have an identical effect may be provided with identical reference signs. Identical components or components having an identical function may be explained only with respect to the figure in which they first appear. The explanation is not necessarily repeated in subsequent figures.

FIG. 1 shows an example embodiment of an electrically adjustable piece of furniture;

FIG. 2 shows a schematic representation of a linear actuator;

FIG. 3 shows an example embodiment of a brake arrangement for bidirectional braking action;

FIGS. 4A, 4B, 4C, 5A, 5B and 5C show various example states of a brake arrangement;

FIG. 6 shows details of an example brake chamber;

FIG. 7 shows details of an example spring-based resetting device;

FIGS. 8A and 8B show various views of an example brake assembly with an electromagnet;

FIG. 9 shows details of an example linear actuator with brake assembly;

FIG. 10 shows details of an example end cap with brake assembly; and

FIG. 11 shows an example embodiment of a linear actuator with a brake assembly.

### DETAILED DESCRIPTION

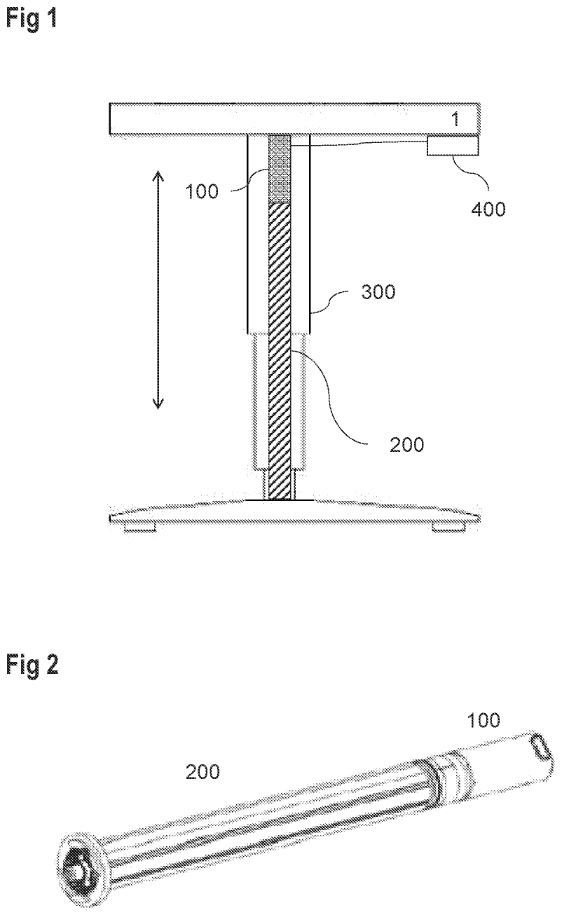

FIG. 1 shows a schematic structure of an electrically adjustable piece of furniture, which is designed as a height-adjustable table. The table comprises a table top 1, the height of which can be adjusted via an actuator system, in this case a linear actuator formed by a motor arrangement 100 and a conversion arrangement, e.g. a spindle-nut system 200. The conversion arrangement is configured to convert a rotational motion generated by the motor arrangement 100 into a linear displacement or length change or elongation of the linear actuator. The linear actuator is arranged in a telescopic column 300. The motor arrangement 100 is connected to a control unit 400 via which a user can, for example, input motion commands for the table in order to effect a height adjustment.

FIG. 2 shows a perspective view of a linear actuator formed by a motor arrangement 100 and a spindle-nut system 200 as an example of a conversion arrangement. The motor arrangement 100 comprises a rotating axis, for example a motor shaft, which is mechanically coupled to the spindle-nut system 200, which converts the rotating motion into an elongation or linear displacement of the linear actuator. Instead of the spindle-nut system 200, another type of conversion arrangement can also be used, which is coupled to the motor shaft and configured to convert rotational motion generated by the motor shaft into elongation of the linear actuator, for example based on wire rope hoists. The elongation of the linear actuator, i.e. its actuator action, takes place, for example, in the longitudinal direction of the motor shaft.

In various embodiments, a motor control or actuator control may be integrated in the control unit 400 or separately from the control unit in its own housing or on or in the linear actuator 100.

For example, as mentioned, spindle nut systems are used to convert rotational motion to linear motion in a linear actuator. However, when a load is applied axially to the nut of the spindle-nut system, and the load is large enough to overcome the friction present, the opposite happens and the linear motion is converted to rotational motion. This is usually an undesirable effect. Although such an effect can occur regardless of the orientation of the spindle, backdrive most often occurs in vertical applications when a load is stopped and an external holding mechanism such as a brake or counterweight fails.

For example, in conventional linear actuators and actuator systems, such an effect occurs, for example, in table furniture with vertically adjustable tabletops, where the load of the tabletop is transferred to the actuator via a mechanism. Under certain circumstances, such an effect can also occur during transport of the table, when the table is lifted at the tabletop. The forces that can trigger the backward drive or a downward slide are determined, for example, by the moving parts of the table frame, such as the weight and/or inertia of these parts.

It has been found that the efficiency of a linear actuator is the main indicator of whether or not a spindle takes over the backward drive or slides down. The higher the efficiency, the more likely it is that the spindle or linear actuator will slip when an axial force is applied, i.e. a force along the direction of length change.

The efficiency of the linear actuator with a spindle-nut system is determined in particular by the pitch angle of the spindle and the friction in the spindle-nut system. The greater the pitch angle, the higher the efficiency of the spindle. This means that spindles with a higher pitch, for example 20 mm per revolution instead of 5 mm per revolution, have a higher efficiency and therefore tend to slip more. In addition to the pitch angle, lubrication or a geometry of the gearing, for example, also influence efficiency, as these affect friction.

In various embodiments, a motor of the linear actuator may drive the conversion arrangement directly or by means of an intermediate speed reduction gear. Such a speed reduction gear may also be integrated in the motor, in which case it may be referred to as a geared motor. Such a linear actuator is self-locking if the entire chain consisting of motor, optional gearbox and conversion arrangement is self-locking, i.e. if, for example, only the spindle of a spindle-nut system is self-locking on its own, for example due to friction or the lubrication pitch angle, etc., or if the spindle is self-locking in combination with the speed reduction gear and/or the motor. In the case of the motor, for example, friction from carbon brushes, bearings or magnetic detent torques can affect self-locking.

High self-locking reduces the overall efficiency of the linear actuator, which requires a larger and more expensive motor.

According to the improved drive concept, it is proposed to equip the actuator system with a brake arrangement.

As a basic principle, such a brake arrangement is based on a frictional locking principle, which can be selectively activated and deactivated and, for example, automatically enables an increase in the self-locking of the actuator system.

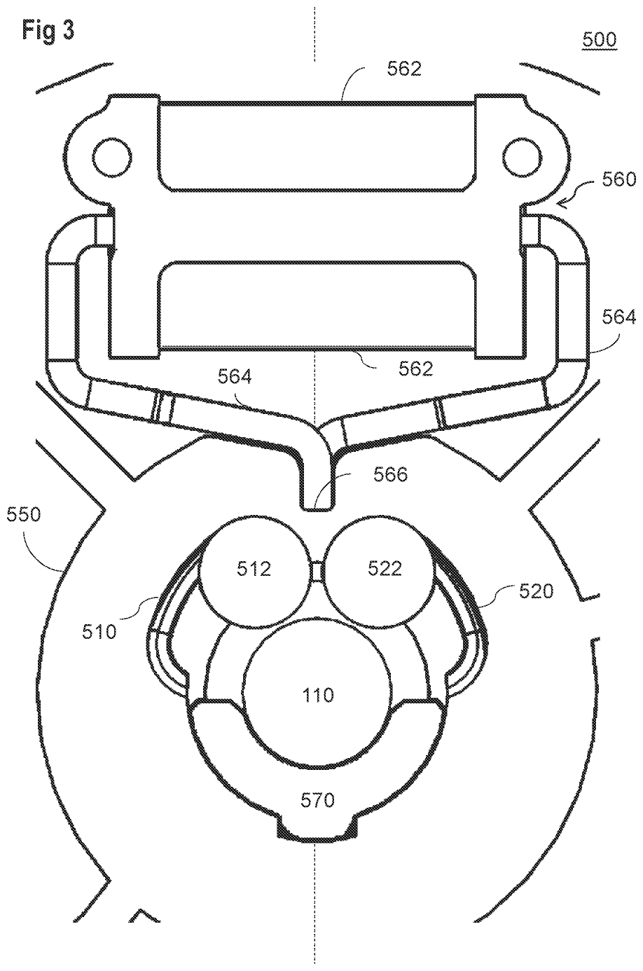

FIG. 3 shows a potential embodiment of such a brake arrangement for use in an actuator system. The actuator system is assumed to comprise a motor with a system of rotating shafts which are driven by the motor interdependently. The system of rotating shafts is formed, for example, by a motor shaft, on which, for example, a rotor is rigidly mounted, and a gear shaft of an optional speed reduction gear, as well as a spindle shaft as part of a conversion arrangement, which is configured to convert a rotational motion of the spindle shaft generated by the motor into an elongation of the actuator system. In the case of a direct drive without a speed reduction gear, the gear shaft can also be omitted. In principle, the system of rotating shafts may also be formed by only a single shaft that serves simultaneously as the motor shaft and the spindle shaft of the conversion arrangement.

The brake arrangement 500 comprises, or utilizes, one of the rotating shafts as a brake shaft 110, and further comprises an electromagnet 560 and at least one brake chamber formed between the brake shaft 110 and an associated brake wall 510, 520 having a wall surface substantially parallel to an axis of rotation of the brake shaft. In the embodiment, the axis of rotation extends perpendicularly into the image. In the embodiment of FIG. 3, two brake chambers are formed by the brake walls 510 and 520. For each brake chamber, the brake arrangement 500 comprises a magnetoactive brake member 512, 522 disposed in the respective brake chamber. The brake members are, for example, cylindrical or cylindrical in shape and are shown here only in sectional view.

In the present example, the brake assembly further comprises a support for the brake shaft 110 formed by a bearing component 570. The bearing component 570 does not completely enclose the brake shaft 110, at least in sections. As a result, the bearing component 570 at least partially faces the two brake chambers. The brake walls 510, 520 are formed in an annular body 550 around the brake shaft 110 and are rigidly coupled to a housing, for example, so that the brake assembly 500 does not rotate with the brake shaft 110.

The electromagnet 560 includes a coil 562 and a coil core that passes through the coil 562 and extends outwardly on both sides as arms 564. Poles 566 of the electromagnet are formed at each end of the arms 564, only one of which is visible based on the sectional view. The electromagnet 560 is configured to bring each brake member 512, 522 into the associated free-wheeling region in an activated state.

Each brake chamber comprises a free-wheeling region configured to receive the respective brake member 512, 522 such that the brake member does not make frictional contact with the brake shaft 110. In the present embodiment, the brake members 512, 522 are located in this respective free-wheeling region.

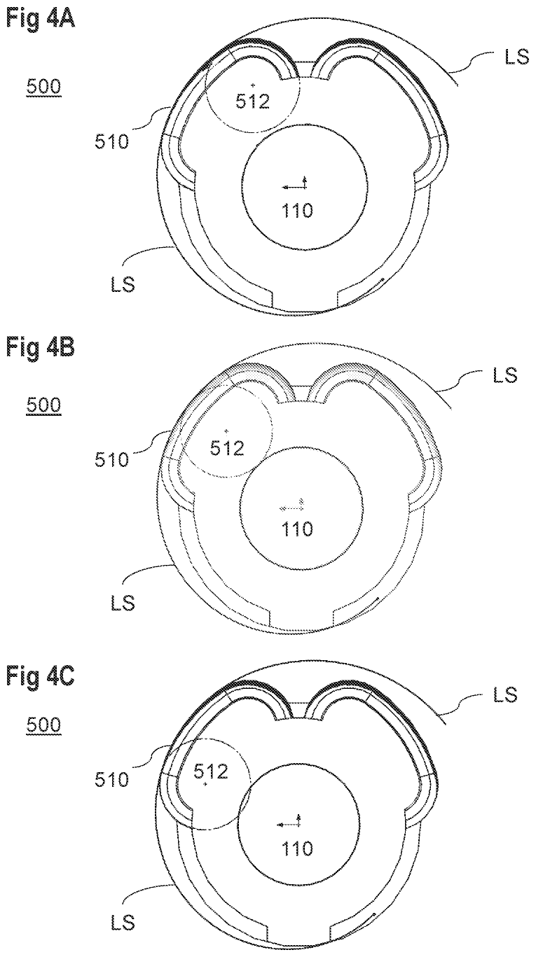

Further, each brake chamber comprises a braking region in which a radial distance between the brake wall 510, 520 and the axis of rotation 110 along the brake wall decreases, for example continuously decreases, starting from the free-wheeling region. This will be explained in more detail below in connection with FIGS. 4A to 4C.

Each brake member 512, 522 is movably arranged in the respective brake chamber in such a way that, depending on a position in the brake chamber, a frictional contact can be formed between the brake member 512, 522 and the brake shaft and between the brake member 512, 522 and the corresponding brake wall 510, 520.

Characteristic of the brake arrangement is the shape of the brake chambers and in particular of the brake walls 510, 520 which outwardly define the brake chambers. In operation of the brake arrangement 500, the braking members 512, 522 can respectively nestle against or move along the associated brake walls. In the example shown in FIG. 3, two brake chambers with respective brake walls and one brake member each are shown by way of example, which are symmetrical with respect to each other. In principle, however, the brake arrangement 500 can also be equipped with only a single brake chamber, which would develop a braking effect in only one direction in an implementation according to FIG. 3. Other implementations are not excluded, for example also a higher number than two brake chambers, whereby a representation is omitted for overview reasons.

A possible course of a brake wall 510 is shown by way of example in connection with FIGS. 4A, 4B and 4C, which differ only in the depicted position of the brake member 512.

In the embodiment of FIG. 4A, the brake member 512 is in a free-wheeling position in which the brake member is not in frictional contact with the brake shaft 110. This region of the brake chamber may also be referred to as the free-wheeling region. The radial distance between the axis of rotation of the brake shaft 110 and the brake wall 510, i.e. the outer contour in the illustration, is greater than the radius of the roller- or cylinder-shaped brake member 512. The radial distance decreases starting from this free-wheeling region, moving downwards in the illustration, and tapers, so to speak, along the brake wall 510.

This can be seen, for example, in FIG. 4B, where the radial distance is reduced such that the brake member 512 begins to make contact with both the brake wall 510 and the brake shaft 110. This tapered region corresponds to a braking region, as a braking effect occurs due to the clamping force generated and the increased rolling friction caused thereby.

During the braking process, elastic deformation of the brake member 512 and/or the brake shaft 110 may occur as the radial distance continues to decrease. In order to prevent excessive jamming and thus, in particular, plastic deformation of the brake member 512 and/or the brake shaft 110, the brake wall in this example also comprises a boundary region, which can be seen in particular in FIG. 4C. In this limiting region, the course of the brake wall 510 changes in such a way that further jamming of the brake member 512 is prevented, in the representation of FIG. 4C corresponding to a further downward movement. A braking effect also occurs in this limiting region, although it reaches its maximum value at this point, for example.

Especially in the braking region, the radial distance decreases, in particular continuously or strictly monotonously. Such a progression is given, for example, by a logarithmic spiral LS, which is also shown to illustrate the contour of the brake wall 510.

In summary, the free-wheeling region serves to receive the brake member when the brake member is held by the magnetic field of the electromagnet. In this free-wheeling region, the brake member 512 has no contact with the brake shaft 110, or at least no frictional contact. The braking region is shaped, for example, such that the distance to the shaft varies along the length of the braking region. At all positions within the braking region, the brake member 512 is in contact with the brake shaft 110, with the contact pressure increasing along the length as the distance continuously decreases. In the optional limiting range, the limiter limits the travel of the brake member 512, resulting in a maximum overlap between the brake shaft 110 and the brake member 512, which results in a defined maximum contact pressure and thereby a defined maximum holding torque. The limiter can ensure that even at high dynamic loads above the maximum holding torque, rotation of the brake shaft 110 is basically possible without causing unnecessary wear or damage to the brake member 512 or the shaft 110. This makes it possible to use the brake arrangement 500 as an overload brake.

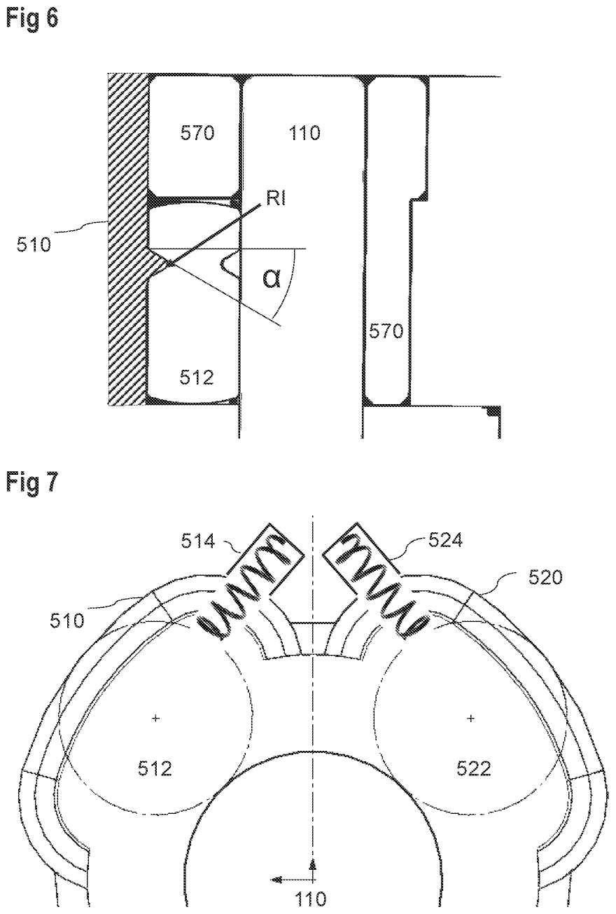

In addition to varying the distance from the brake shaft 110, the brake wall 510 may also comprise another optional feature to provide or improve guidance of the brake member 512. For example, such guidance is provided by an edge that protrudes from the brake wall and engages a groove in the brake member 512. For example, such a groove is formed rotationally symmetrically in an outer wall, in particular lateral surface of the brake member. For example, the edge is shown in FIGS. 4A to 4C as extending inwardly from the brake wall 510 and partially overlapping with the brake member 512. The implementation is explained in more detail below in connection with FIG. 6.

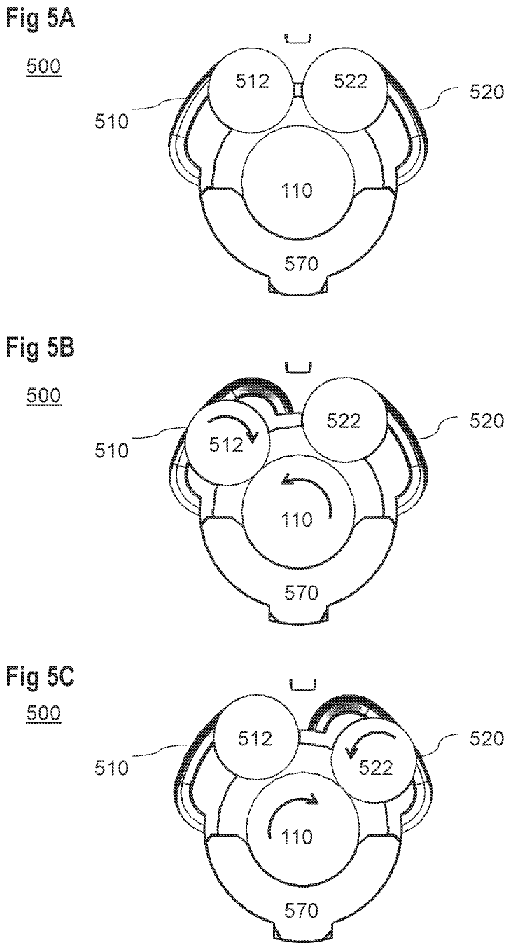

Referring to FIGS. 5A, 5B and 5C, the principle of the braking effect of the brake arrangement 500 will be explained in more detail. As explained above, the braking effect of the brake arrangement 500 is basically generated by friction between the brake member, the brake wall and the brake shaft. In the representation of FIG. 5A, both brake members 512, 522 are in their respective free-wheeling position, which is why the brake arrangement 500 is accordingly in a free-wheeling state. In this free-wheeling state, in particular, the electromagnet, symbolically shown via its poles 566, is activated to hold the brake members 512, 522 securely in this position.

In addition to the free-wheeling state, the brake arrangement 500 can also assume at least one braking state. In the at least one braking state, at least one brake member has frictional contact with the brake shaft. This is illustrated, for example, in FIGS. 5B and 5C, respectively for different directions of rotation of the brake shaft 110. In these braking states, the electromagnet is deactivated and the brake members are not selectively held in their respective free-wheeling position.

Under the exemplary assumption that the brake shaft 110 is horizontal as shown, both brake members 512, 522 can in principle drop downward in their respective brake chambers, so to speak, to come into frictional contact with the brake shaft 110.

With reference to FIG. 5B, the brake shaft 110 is assumed to rotate in a counterclockwise direction. This causes the first brake member 512 to rotate clockwise as a result of the frictional contact and to develop its braking effect. At the same time, the rotational motion causes a lateral movement of the first brake member in the direction of the taper, which further enhances the braking effect. The second brake member 522 develops no braking effect or at most a negligible braking effect, since the frictional contact with the brake shaft 110 only causes a movement of the second brake member 522 in the direction of the free-wheeling region in the second brake chamber.

FIG. 5C is essentially the same as FIG. 5B, with the direction of rotation of the brake shaft 110 reversed. Thus, the braking action here is caused by the second brake member 522, while the first brake member 512 is essentially uninvolved.

As soon as one of the brake members reaches the optional limitation range, the respective braking effect remains at a defined maximum level, regardless of the level of the output force. The respective brake member is thereby in frictional engagement with the brake shaft 110 and has maximum contact. In the case of high dynamic loads, for example because even greater torques occur when a heavy table top is stopped due to inertia of the table top, the brake arrangement 500 can act as an overload brake. In other words, the present brake arrangement still allows the brake shaft 110 to rotate, in contrast to a blocking arrangement based on a form-lock principle. As a result, energy from the torque can be converted into friction and thus dissipated after a few revolutions. A rotational motion of the brake shaft thus ends, for example, not abruptly as in the case of locking, but more softly, for example as a so-called soft stop.

As already mentioned, the brake members can be cylindrical in shape, for example as rollers or rolls. The use of cylindrical brake members distributes the contact pressure over a larger area of the shaft, which results in lower punctual material stress and a longer service life of the components involved. To increase the reliability of the arrangement, it can be ensured that the brake members are clamped between the brake wall and the brake shaft after the magnetic field is switched off. Accordingly, it can be ensured that they leave their respective free-wheeling position in the free-wheeling region of the brake chambers so that they come into contact with the rotating brake shaft and are carried along and clamped by it. There are various ways for the brake members to reliably leave their respective free-wheeling position in the vicinity of the electromagnet and thus come into contact with the rotating brake shaft. For example, the gravitational force acting on the brake member(s) can be used for this purpose.

For example, the annular body 550 could be given a bottom that is inclined in the direction of the brake shaft 110. This would cause the brake member to be pulled in the direction of the brake shaft 110 by the gravitational force.

FIG. 6 shows another possibility that utilizes a gravitational force acting on the brake member 512. Shown here is a sectional view through the brake shaft 110, the brake member 512 and the brake wall 510, as well as the bearing component 570. The brake wall 510 comprises an edge that engages in a groove RI that extends rotationally around the brake member 512. Depending on the position within the brake chamber, the distance between the brake wall 510 and the brake shaft 110 varies, so that the brake member 512 can slide along an inclined plane in the direction of the brake shaft 110, in particular in the free-wheeling region of the brake chamber. The inclined plane is thereby formed by the upper side of the edge in the brake wall 510, and in this example comprises an angle a to the horizontal. The groove RI is provided in the upper half of the brake member 512, for example, so that the brake member always aligns itself vertically via gravity. This makes it possible to prevent the brake member from tilting within the brake chamber.

As mentioned, the shape of the edge is, for example, wedge-shaped, with the angle of this wedge corresponding to the angle a of the inclined plane. As long as the brake member is not yet in contact with the brake shaft, there is a possibility that the brake member will slide on this inclined plane in the direction of the brake shaft. However, as soon as contact with the brake shaft occurs, the rotational motion of the brake shaft takes the brake member with it and clamps it. This then pushes the brake member back up a little onto the edge. The combination of edge and groove serves, among other things, to prevent jamming by suspending the brake member on the edge, and also to realize the inclined plane.

From the illustration of FIG. 6, it can be additionally seen that the bearing component 570 comprises an area which does not completely enclose the brake shaft 110, namely in the area in which the bearing component 570 faces the brake member 512, as well as another area in which a complete enclosure of the brake shaft 110 is possible, namely above the brake member 512.

Another way to implement a reset mechanism for the brake member(s) is to use a spring force. This is illustrated, for example, in FIG. 7. For example, the brake walls 510, 520 comprise corresponding spring elements 514, 524 which bias the respective brake members towards the brake shaft 110. As long as the magnetic field of the electromagnet 560 is switched on, the resulting magnetic force on the brake members overcomes the spring force and holds the brake members in the free-wheeling position. Once the magnetic field is turned off, the spring force of the spring elements 514, 524 pushes the brake members 512, 522 into the brake chamber such that contact is made with the brake shaft 110.

When using the gravitational force, it may be necessary to select the orientation of the brake shaft 110 or the brake chambers during operation of the actuator system in such a way that a corresponding movement of the brake members is possible due to the gravitational force. This can be achieved, for example, by appropriate specifications for the installation direction, which can be supported by markings on the housing. With a vertical installation of the brake shaft 110 and an example arrangement according to FIG. 6, the reset mechanism is inherently given.

The described reset mechanisms via gravitational force and spring force can be combined.

In the case of electrically adjustable furniture, it must or should be ensured that the position reached does not change after the end of the movement of the adjusting mechanism, in particular the actuator. Neither may the movement of the adjusted furniture part continue after the motor is switched off due to the inertia of this furniture part, nor may the furniture part change its position independently afterwards, e.g. start to slide. The actuator should stop immediately or after a short time, even if a torque is still acting on the output side.

Typically, this is achieved by high gear ratios and moments of inertia or low efficiencies, e.g. combined with high self-locking.

It would be advantageous to have a linear actuator that has no or only very low self-locking during operation so as to require little power and has sufficiently high self-locking at standstill.

If one now combines an actuator which is conventional in itself with the brake arrangement described in accordance with the improved drive concept, in which the brake acts on the motor shaft, for example, then one obtains such an ideal actuator.

If the linear actuator causes an adjustment of a furniture part (operating case), then the magnetic field is activated and the linear actuator acts with minimal self-locking and little additional power for the magnetic field.

If the linear actuator does not cause an adjustment of a furniture part (standstill), or a voltage failure occurs during the adjustment, then the magnetic field is deactivated and the linear actuator acts with maximum self-locking, whereby the self-locking automatically becomes stronger the higher the force on the output side is. If necessary, the self-locking is limited by a limiter in the brake wall.

Control is provided, for example, by an actuator control, such as with a processor on a circuit board in the actuator, or also by a separate actuator control in a unit separate from the actuator, such as in the control unit 400.

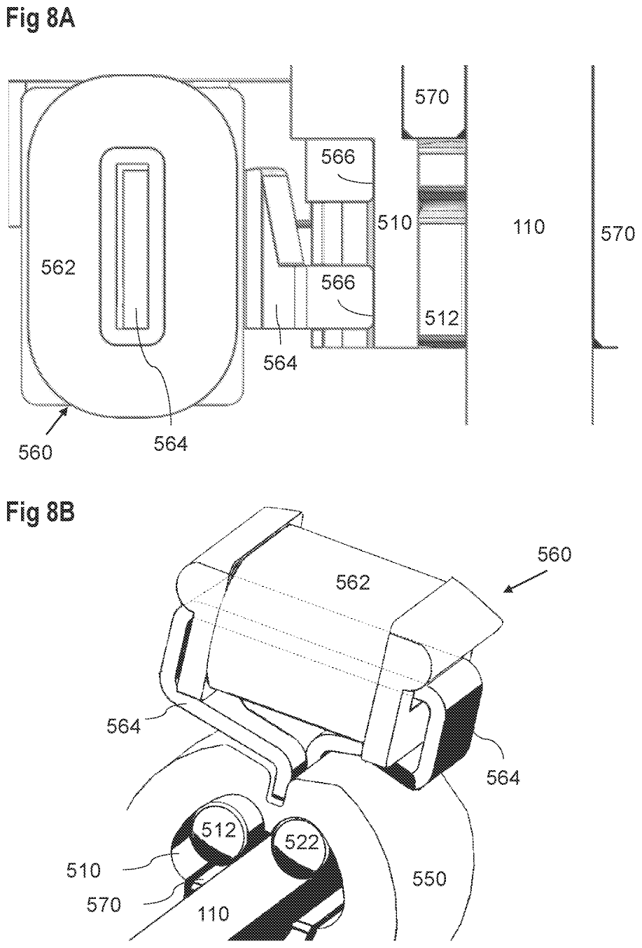

In FIGS. 8A and 8B, different views of the brake arrangement 500 with the electromagnet 560 are shown, with FIG. 8A showing a sectional view through the brake shaft 110 and the electromagnet 560 and FIG. 8B showing a perspective view of the arrangement.

The right-hand portion of FIG. 8A is substantially the same as that shown in FIG. 6, with the cutaway portion of brake wall 510 corresponding to the free-wheeling region, particularly at the point where the brake member(s) 512, 522 are closest to electromagnet 560. In this example embodiment, the brake wall 510 is formed as part of the annular body 550 which, with reference to FIG. 8B, comprises a notch in the central region in which the poles 566 of the electromagnet engage. The poles 566 thereby form the ends of the arms 564 of the coil core, which are more clearly visible in FIG. 8B. The poles 566 form a straight line parallel or substantially parallel to the axis of rotation. In particular, it can be seen from the sectional view in FIG. 8A that the coil core is enclosed by the coil 562.

As explained above, the electromagnet 560 serves to move the one or more brake members 512, 522 to the free-wheeling position where they are each out of contact with the brake shaft 110 and to hold them there. Accordingly, the brake member or members are designed to be attracted by a magnetic field, that is, they are magnetoactive. This can be achieved, for example, by appropriate selection of a material, such as a ferrous or ferromagnetic material in or on the brake member.

When no braking action is required, the electromagnet 560 is turned on, for example via a current flow through the coil 562. In order to allow the resulting magnetic field to pull the brake member(s) out of a possibly clamped position in the braking region, it is proposed to rotate the brake shaft 110 by the motor of the actuator system so as to loosen the brake member(s). This can be accomplished, for example, by rotating the brake shaft in a direction opposite to the previous braking direction. The direction of rotation for unlocking or unclamping is initially independent of a desired direction of rotation of the rotating shaft system, by which a change in elongation of the actuator system is to be achieved.

When a braking effect is required, the electromagnet 560 is turned off. Thus, a braking effect occurs, for example, when a power failure occurs. To minimize the amount of energy required for the electromagnet in the free-wheeling state, it may be advantageous to optimize the orientation of the magnetic field. With reference to FIGS. 8A and 8B, this is achieved, for example, by bringing the poles 566 of the electromagnet 560 as close as possible to the braking chamber and the free-wheeling region, respectively, to take advantage of the higher strength of the magnetic field at the poles. Further, the poles 566 are spaced a uniform distance from the free-wheeling region and the brake members 512, 522, respectively, which results in a uniformly acting magnetic force on the brake member(s). For example, the magnetic field lines between the poles 566 are substantially parallel to an axis of rotation of the brake members. This can ensure that the cylindrical brake member or members do not tilt when the magnetic field is activated. Furthermore, it can be achieved that the brake members optimally lie against or in the wall surface and, for example, nestle completely against the wall surface.

Another way of minimizing the energy requirement of the electromagnet during operation of the actuator system is to lower the current through the coil 562 when the brake member or members are already in the respective free-wheeling position. This is because the force required to hold the brake member(s) in the free-wheeling position is less than a force required to move the brake member(s) from, for example, a jammed position to the free-wheeling position.

As explained above, the brake arrangement 500 may be mounted at various locations in an actuator system. For example, the brake shaft is a motor shaft, a gear shaft, or a spindle shaft of the conversion arrangement, or another shaft in the actuator system that is driven depending on the motor shaft. For example, if the brake shaft is formed by the motor shaft, the brake arrangement 500 may be integrated within a motor housing of the motor.

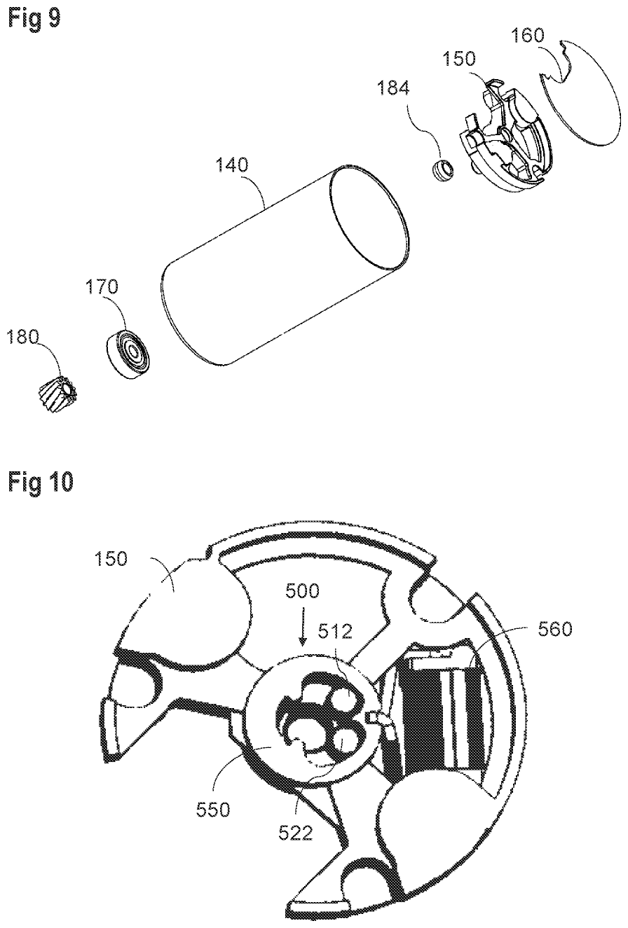

FIG. 9 shows an exploded view of an example motor arrangement 100. The motor comprises, for example, a housing 140, which is designed as a pot-like cylinder, which is substantially closed at a first end face and comprises only a bushing (not visible) for an axle (not shown). At a second end face, the housing 140 is open to receive motor components such as rotor, stator, etc., as well as the motor shaft. The second end face of the housing 140, which is opposite the first end face, is terminated, for example, by an end cap 150 and an end plate 160. In the region of the first end face, a bearing 170 and a gear wheel 180 are additionally shown, which is emblematic of a gear unit to be connected or a spindle nut system as a conversion arrangement. A plain bearing bushing 184 serves, for example, to support the motor shaft in the end cap 150.

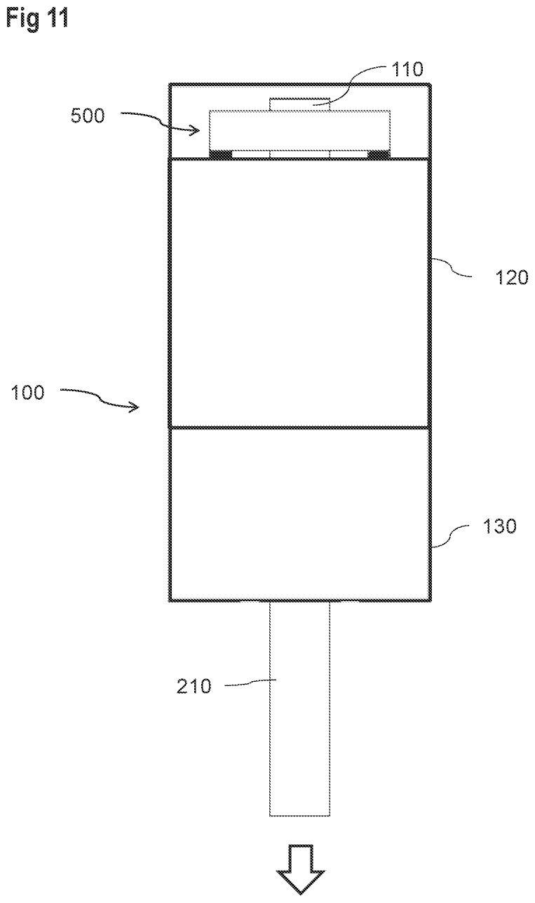

FIG. 10 shows an example embodiment in which the brake arrangement 500 is integrated in or on the end cap 150. The brake arrangement 500 is again implemented, for example, with a brake ring 550, which implements the brake chambers through the inner brake walls. The annular body 550 can be applied to the end cap, in particular in the area of the bearing bushing, and be rigidly or non-rotatably connected to the end cap 150. Alternatively, the annular body or brake walls may also comprise an inseparable part of the end cap 150 and may, for example, be milled, cast or otherwise manufactured together from a material. Because of the simplicity of the arrangement, very compact dimensions and installation in actuator systems, particularly in contemporary linear actuators, are feasible without requiring additional space. For example, the annular body comprises a height or thickness of a few millimeters.

FIG. 11 shows an example implementation of an actuator system with a motor arrangement 100, which in this example embodiment consists of the electric motor 120, a gearbox 130, which serves for example as a speed reduction gear, and a symbolic spindle shaft 210 of a conversion arrangement. Other elements of the conversion arrangement other than the spindle 210 are not shown for overview purposes. The motor arrangement 100 further comprises a motor shaft used as a brake shaft 110. The brake arrangement 500 is arranged on the brake shaft and is non-rotatably connected to a housing of the electric motor 120.

A control of such actuator system, in particular by the actuator control, can be divided into different operating procedures.

For example, to start the movement of the actuator system, i.e. to change the elongation, the magnetic field is switched on, for example with high strength. In addition, the brake members are loosened by a rotational motion of the brake shaft 110, for example, by generating motor signals that rotate the motor.

During a movement or change in elongation, the magnetic field is maintained, whereby a lower strength of the magnetic field can be used for this purpose. In addition, motor signals are generated that rotate the motor in the desired direction of rotation to produce a desired change in elongation.

To stop the movement, in particular when the movement is to be stopped permanently, the motor is switched off or no longer actively controlled, and the magnetic field is also no longer actively maintained or deactivated.

If a sufficient, output-side force occurs when the actuator is at a standstill, then the brake activates automatically and without energy input, where sufficient means approximately that a weight force is higher than an initial drive friction, i.e. before the drive friction becomes greater due to the self-locking effect increasing as a result of the braking effect. Such an output-side force can occur, for example, due to the weight force of a tabletop on the actuator in a table leg. However, it can also occur when a person carries a table. In this case, a person usually lifts the table by the tabletop, creating an upward force. Since both situations are common in practice, the brake arrangement with two braking directions is also a favorable embodiment.

Before the linear actuator can make an adjustment after coming to a standstill, it must be ensured that the brake members can be attracted by the magnetic field. They must therefore first be brought out of a potentially jammed position, i.e. “loosened”.

To do this, the actuator control generates motor signals that rotate the motor. This rotational motion can be at a different speed than the rotational motion used for an adjustment. It is also conceivable that the motor is rotated in different directions in quick succession.

The actuator control uses motor signals to move the motor, e.g. several signal lines for multi-phase motors, and additionally a signal to energize the coil of the solenoid. Here, for example, 80% PWM is used for the coil when the solenoid is turned on and 40% PWM is used after about one second as a reduced holding current during movement.

An actuator control processor could use a processor output, particularly a PWM output, to drive a transistor to switch an operating voltage, e.g., 30 VDC, in a pulse-width modulated manner to the coil 562 of the electromagnet 560.

According to the improved drive concept, an actuator system or linear actuator with variable self-locking can be provided. This comprises one or more of the following features, depending on the embodiment:

The brake arrangement enables gentle braking, especially in contrast to hard braking, which leads to higher material stress. No additional rotating parts are required in the arrangement, so manufacturing such an actuator system is not complicated. A compact brake is made possible, which can be integrated in the linear actuator or in the motor and does not change the size of the actuator system or does not change it significantly. The self-locking of the actuator system is variable, because at standstill there is a large self-locking due to the brake members, while during a movement the self-locking is minimal. Self-locking at standstill does not require any additional power. During movement, when the magnetic field is switched on or activated, only little additional power is required for the magnetic field. Slipping of the drives or the actuator system for operation is prevented despite low self-locking. Even in the event of a sudden power failure, safety is ensured by the braking effect that then commences. The self-locking automatically adjusts itself, as this automatically increases with greater load due to the increasing clamping effect with greater load. The actuator system is also overload-proof because of the automatically adapting self-locking.

1. An actuator system, in particular for adjusting a piece of furniture, the actuator system comprising:
a motor comprising a system of rotating shafts which are driven interdependently by the motor;
a conversion arrangement which comprises one of the rotating shafts and is arranged to convert a rotational motion of this shaft generated by the motor into an elongation of the actuator system; and
a brake arrangement comprising:
one of the rotating shafts as a brake shaft;
an electromagnet;
at least one brake chamber defined by a region between the brake shaft and an associated brake wall having a wall surface substantially parallel to an axis of rotation of the brake shaft; and
for each brake chamber, a magnetoactive brake member disposed within the respective brake chamber;
wherein:
each brake chamber comprises a free-wheeling region configured to receive the respective brake member such that the brake member is not in frictional contact with the brake shaft;
each brake chamber comprises a braking region in which a radial distance between the brake wall and the axis of rotation along the brake wall decreases, starting from the free-wheeling region;
each brake member is movably arranged in the respective brake chamber in such a way that, depending on its position in the brake chamber, a frictional contact between the brake member and the brake shaft and between the brake member and the brake wall is formable; and
the electromagnet is configured to bring each brake member into the associated free-wheeling region in an activated state.

2. The actuator system of claim 1, wherein each brake chamber comprises a limiting region in which the respective brake wall comprises a limiter for limiting movement of the respective brake member along the respective brake wall.

3. The actuator system according to claim 1, wherein the brake arrangement is configured to move the respective brake member in the associated brake chamber in a direction in which the radial distance decreases by frictional contact of the respective brake member, so that a clamping force between the respective brake member and the associated brake wall and the brake shaft increases.

4. The actuator system according to claim 1, wherein the brake arrangement comprises at least two brake chambers, wherein each of two possible braking directions is associated with at least one of the brake chambers.

5. The actuator system according to claim 1, wherein the respective brake walls are formed in an annular body around the brake shaft.

6. The actuator system according to claim 5, wherein the respective brake chambers are arranged regularly around the brake shaft.

7. The actuator system according to claim 1, wherein the radial distance between the brake wall and the axis of rotation varies according to a logarithmic spiral.

8. The actuator system according to claim 1, wherein the brake arrangement comprises a support for the brake shaft that prevents or reduces bending of the brake shaft during braking.

9. The actuator system according to claim 8, wherein the support is formed by a bearing component for the brake shaft, which at least section-wise does not completely enclose the brake shaft in such a way that the bearing component at least partially faces a braking chamber with respect to the axis of rotation.

10. The actuator system according to claim 1, wherein each brake member comprises a rotationally symmetrical groove or notch, and each brake wall comprises an edge that engages in the respective groove or notch of the associated brake member.

11. The actuator system according to claim 1, wherein the electromagnet comprises at least one pair of magnetic poles forming a straight line parallel or substantially parallel to the axis of rotation.

12. The actuator system according to claim 1, wherein the electromagnet comprises a coil and a coil core, wherein parts of the coil core located outside the coil form arms of the electromagnet, at the ends of which poles of the electromagnet are formed.

13. The actuator system according to claim 1, wherein each brake wall further comprises a respective reset mechanism configured to bring the associated brake member into contact with the brake shaft when the electromagnet is not activated.

14. The actuator system according to claim 13, wherein the reset mechanism is formed by at least one inclined plane that is radially inclined with respect to the brake shaft such that a gravitational force acts on the respective brake member.

15. The actuator system according to claim 13, wherein the reset mechanism is formed by at least one spring element by which the respective brake member is biased towards the brake shaft.

16. The actuator system according to claim 1, further comprising an actuator control, wherein:
the brake arrangement is configured to assume a free-wheeling state and at least one braking state;
in the free-wheeling state, each brake member is in the respective free-wheeling region;
in the at least one braking state, at least one brake member has frictional contact with the brake shaft; and
the actuator control is configured to activate the electromagnet and drive the motor to rotational motion of the brake shaft to enable a change in elongation of the actuator system when the brake arrangement is in the at least one braking state.

17. The actuator system according to claim 16, wherein the actuator control is further configured to activate the electromagnet at a first intensity to move the brake arrangement from the at least one braking state to the free-wheeling state and to activate the electromagnet at a second intensity to maintain the brake arrangement in the free-wheeling state, wherein the first intensity is greater than the second intensity.

18. The actuator system according to claim 16, wherein a transition of the brake arrangement from the free-wheeling state to the at least one braking state is effectable by driving the motor to a rotational motion of the brake shaft and/or by applying force to the conversion arrangement along a direction of elongation, while the electromagnet is deactivated, respectively.

19. The actuator system according to claim 16, wherein the actuator control is further configured to activate the electromagnet with a pulse width modulated voltage.

20. A piece of furniture comprising at least one adjustable component and comprising an actuator system according to claim 1 for adjusting the component.

21. A method for controlling an actuator system according to claim 1, wherein
the brake arrangement is configured to assume a free-wheeling state and at least one braking state;
in the free-wheeling state, each brake member is in the respective free-wheeling region; and
in the at least one braking state, at least one brake member has frictional contact with the brake shaft;
the method comprising:
enabling a change in elongation of the actuator system when the brake arrangement is in the at least one braking state,
activating the electromagnet; and
driving the motor for a rotational motion of the brake shaft.
